(19) United States
(12) Patent Application Publication
(10) Pub. No.: US 2022/0343184 A1
(43) Pub. Date: Oct. 27, 2022

(54) DATA PROCESSING APPARATUS, LEARNING APPARATUS, INFORMATION PROCESSING METHOD, AND RECORDING MEDIUM

(71) Applicant: NEC Corporation, Minato-ku, Tokyo (JP)

(72) Inventors: So YAMADA, Tokyo (JP); Riki ETO, Tokyo (JP); Junko WATANABE, Tokyo (JP); Ryota SUZUKI, Tokyo (JP); Hiromi SHIMIZU, Tokyo (JP)

(73) Assignee: NEC Corporation, Minato-ku, Tokyo (JP)

(21) Appl. No.: 17/640,474

(22) PCT Filed: Sep. 18, 2019
(86) PCT No.: PCT/JP2019/036576

§ 371 Date: Mar. 4, 2022

(51) Int. Cl. G06N 5/02; G06N 5/04

(52) U.S. Cl. CPC G06N 5/022; G06N 5/04

(57) ABSTRACT

A learning apparatus acquires learning data in which odor data of each object and a label representing the object in a label space expressing features of odors are associated with each other, and learns, based on odor data, a model for predicting a label of the odor data in the label space, by using the learning data. In a data processing apparatus for processing odor data, an acquisition unit acquires odor data from an outside. A prediction unit predicts a label of the acquired odor data in the label space by using the model in which a relationship between sets of odor data and labels in the label space expressing the features of the odors is learned.

### TECHNICAL FIELD

The present invention relates to an odor data analysis.

### BACKGROUND ART

In recent years, an odor analysis has been carried out using sets of odor data obtained from odor sensors. In the odor analysis, it is desired to quantitatively express a meaningful relationship between the sets of odor data obtained from the odor sensors. For example, it is desired to quantitatively express a relationship between odor data representing an odor of a wine A and odor data representing an odor of a wine B, which are obtained from odor sensors. Moreover, for example, even if odors are completely different genres such as coffee and tire odors, it is desired to quantitatively express an odor relationship in an integrated manner.

Patent Document 1 describes a technique called “word embedding (Word Embedding)” or “distributed representation of words” using, for example, word2vec, Glove, or the like. Incidentally, the “word embedding” or the “distributed representation of words” is a technique to express the meaning of each word by a real number vector of low dimensions.

### PRECEDING TECHNICAL REFERENCES

### Patent Document

Japanese Laid-open Patent Publication No. 2017-151838

### SUMMARY

### Problem to be Solved by the Invention

However, Patent Document 1 is a technique for representing a semantic relationship of a natural language by vectors, it is impossible to quantitatively express a relationship between sets of odor data obtained from odor sensors.

It is one object of the present invention to quantitatively express the relationship between the sets of odor data obtained from the odor sensors.

### Means for Solving the Problem

In order to solve the above problems, according to an example aspect of the present invention, there is provided a data processing apparatus including:

an acquisition unit configured to acquire odor data; and

a prediction unit configured to predict a label of the acquired odor data in a label space by using a model in which a relationship between sets of odor data and labels in the label space expressing features of odors is learned.

According to another example aspect of the present invention, there is provided a learning apparatus including:

a learning data acquisition unit configured to acquire learning data in which odor data of each object and a label representing the object in a label space expressing features of odors are associated with each other; and

a learning unit configured to train a model for predicting a label of odor data in the label space from the odor data, by using the learning data.

According to still another example aspect of the present invention, there is provided an information processing method, including:

acquiring odor data; and

predicting a label of the acquired odor data in a label space by using a model in which a relationship between sets of odor data and labels in the label space expressing features of odors is learned.

According to a further example aspect of the present invention, there is provided a recording medium storing a program, the program causing a computer to perform a process including:

acquiring odor data; and

predicting a label of the acquired odor data in a label space by using a model in which a relationship between sets of odor data and labels in the label space expressing features of odors is learned.

### Effect of the Invention

According to the present invention, it is possible to quantitatively express each relationship among sets of odor data obtained from odor sensors.

### BRIEF DESCRIPTION OF THE DRAWINGS

FIG. 1 illustrates a basic principle using a prediction apparatus in example embodiments.

FIG. 2 is a block diagram illustrating a hardware configuration of a prediction apparatus according to the example embodiments.

FIG. 3 is a block diagram illustrating a functional configuration for learning in a first example embodiment.

FIG. 4 illustrates an example of a label space.

FIG. 5 illustrates another example of a label space.

FIG. 6 is a flowchart of a learning process by the prediction apparatus in the first example embodiment.

FIG. 7 is a block diagram illustrating a functional configuration for prediction in the first example embodiment.

FIG. 8 is a flowchart of a label prediction process by the prediction apparatus in the first example embodiment.

FIG. 9 illustrates a functional configuration of the prediction apparatus conducting a distance calculation process.

FIG. 10 is a flowchart of the distance calculation process.

FIG. 11 illustrates a functional configuration of a prediction apparatus conducting an article proposal process.

FIG. 12 is a flowchart of the article proposal process.

FIG. 13 illustrates a functional configuration of a prediction apparatus conducting an odor data proposal process.

FIG. 14 schematically illustrates an example for determining a label without using the label space.

FIG. 15 illustrates configurations of a data processing apparatus and a learning apparatus according to a second example embodiment.

### EXAMPLE EMBODIMENTS

[Principles]

First, a basic principle in example embodiments of the present invention will be described. A prediction apparatus in the example embodiments expresses odor data with vectors by predicting a label in a certain vector space with respect to input odor data.

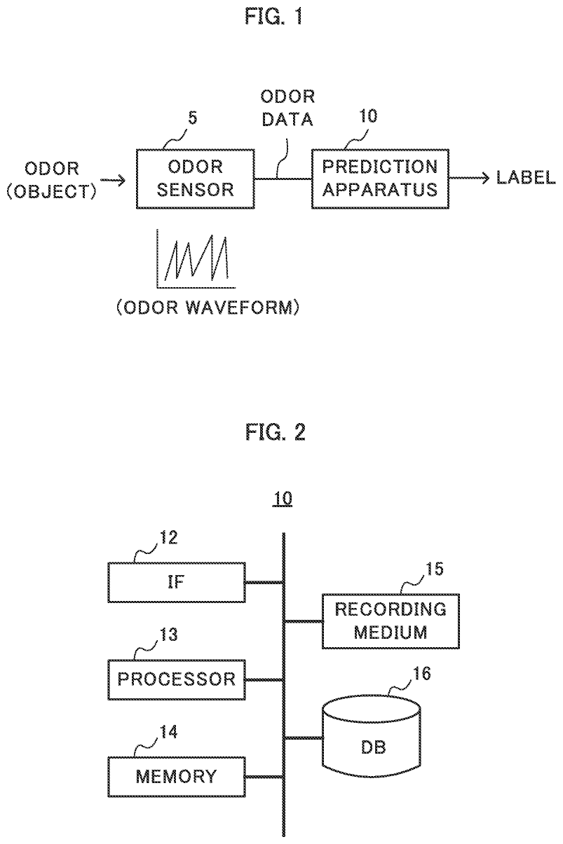

FIG. 1 illustrates the basic principle using the prediction apparatus in the present example embodiments. First, an odor sensor 5 detects an odor of an object, and outputs odor data. The odor sensor 5 may be any one capable of quantitatively obtaining odor data, for instance, a semiconductor type sensor, a crystal oscillation type sensor, an FET biosensor, or the like; however, this case will now be described as using a membrane type surface stress sensor. The odor sensor 5 detects deflection of a detection film when odor molecules adhere to the detection film such as a silicon film, and outputs as a voltage change. Since the deflection of the detection film is different for each odor molecule, the odor sensor 5 outputs a different voltage waveform for each odor (also referred to as an “odor waveform”). Accordingly, by analyzing the odor waveform, various substances can be discriminated. Incidentally, as the odor data, a feature amount representing the odor waveform, which is output from the odor sensor 5 is used. For instance, the odor waveform itself output from the odor sensor 5 for the object may be used, an average value obtained by multiple detections, a value indicating a feature in a shape of the odor waveform, a value, a maximum value, a minimum value, a median value, or the like of a component composition when the odor waveform is decomposed into exponential components can be used as the odor data. Moreover, a preprocess such as noise removal may be performed.

A prediction apparatus 10 predicts a label in a vector space indicating odor features based on input odor data. Because the label in the vector space indicates a vector quantity in that vector space, the odor data are expressed by the vector. By expressing odor data in the vector space, it becomes possible to quantitatively analyze each relationship among multiple odors, and to add and subtract some odors.

### First Example Embodiment

(Hardware Configuration)

FIG. 2 is a block diagram illustrating a hardware configuration of the prediction apparatus according to the first example embodiment. As illustrated, the prediction apparatus 10 includes an interface (IF) 12, a processor 13, a memory 14, a recording medium 15, and a database 16.

The interface 12 communicates with an external apparatus. Specifically, the interface 12 is used to input odor data from the odor sensor 5 or a device that stores sets of odor data, or to output a label obtained as a prediction result to an outside.

The processor 13 is a computer such as a CPU (Central Processing Unit) or a GPU (Graphics Processing Unit) with the CPU, and controls the entire prediction apparatus 10 by executing a program prepared in advance. The memory 14 is formed by a ROM (Read Only Memory), a RAM (Random Access Memory), or the like. The memory 14 stores various programs to be executed by the processor 13. Also, the memory 14 is used as a work memory during executions of various processes by the processor 13.

The recording medium 15 is a non-volatile and non-transitory recording medium such as a disk-shaped recording medium, a semiconductor memory, or the like, and is formed to be detachable from the prediction apparatus 10. The recording medium 15 records various programs executed by the processor 13. When the prediction apparatus 10 executes each of processes described later, such as a label prediction process and the like, a program recorded on the recording medium 15 is loaded into the memory 14 and executed by the processor 13.

The database 16 stores data necessary for processes performed by the prediction apparatus 10. Specifically, the database 16 stores learning data for use in a case of training a model for predicting a label. In addition to the above, the prediction apparatus 10 may include an input device such as a keyboard or a mouse, or a display device.

(Functional Configuration for Learning)

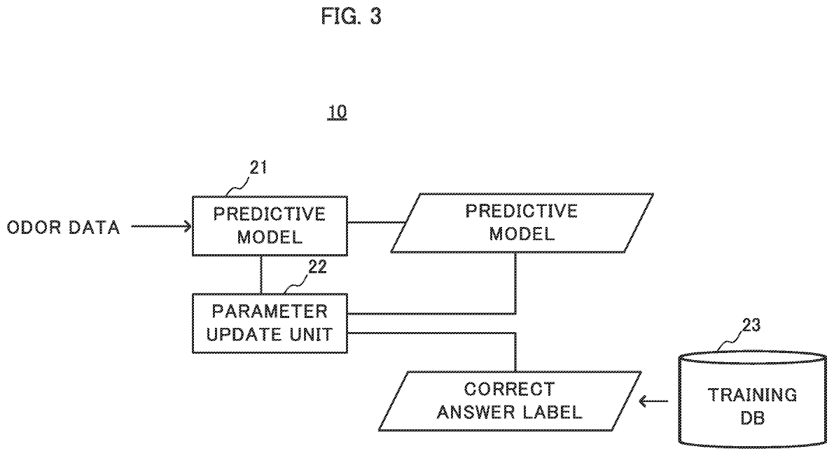

FIG. 3 is a block diagram illustrating a functional configuration for learning. The prediction apparatus 10 functionally includes a predictive model 21, a parameter update unit 22, and a training database (hereinafter, the database is also referred to as a “DB”) 23. The predictive model 21 is a model for predicting a label in a vector space (hereinafter, also referred to as “label space”) indicating odor features from odor data, and is formed by, for instance, a neural network (NN) or the like. The parameter update unit 22 updates a plurality of parameters forming the predictive model 21 in a learning process for the predictive model 21. The training DB 23 stores learning data for training a predictive model.

In the learning of the prediction apparatus 10, the predictive model 21 is trained using the learning data stored in the training DB 23. The learning data are data in which sets of the odor data for various objects are correlated with respective labels representing the objects in the label space. As will be described later, the labels are defined for each label space. During the learning of the prediction apparatus 10, odor data of an object are input to the predictive model 21, and the predictive model 21 predicts a label for the odor data, generates a prediction result (referred to as a “predicted label”), and outputs the prediction result to the parameter update unit 22. The parameter update unit 22 acquires a correct answer label for the odor data of the object from the training DB 23. After that, the parameter update unit 22 calculates an error between the predicted label and the correct answer label, and updates the parameters of the predictive model 21 so that the error is minimized. Thus, the predictive model 21 is trained using the learning data.

(Label Space)

Next, the label space will be described. The label space is a vector space indicating odor features, and is a space in which each label obtained as a prediction result is defined. By expressing odors using labels indicating respective vector quantities in the label space, each relationship among a plurality of odors is quantitatively expressed. For instance, labels located at a close distance in the label space indicate a close odor in that label space, and labels located at an opposite direction in the label space are considered to exhibit odors of contrasting properties in that label space. However, even in the same odor, in a case of a different label space, vectors expressing those odors are different. In the example embodiments, as described below, several label spaces are used to express odors.

(1) Space Expressing a Structure and Chemical Properties of a Substance

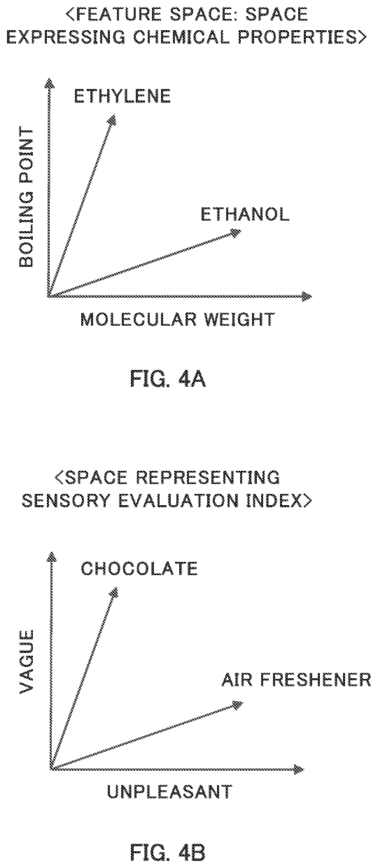

In a first example, we use a space that expresses a structure and chemical properties of a substance as a label space. Since the odor of a substance is thought to be determined by the structure and the chemical properties of the substance, it is considered effective to use a space expressing the structure and the chemical properties of the substance as the label space. Specifically, a vector space centered on an index, which quantitatively expresses a structure and chemical properties of a molecule, is defined as a label space. FIG. 4A illustrates an example in which a vector space based on a “molecular weight” and a “boiling point” as the chemical properties of the substance is used as the label space and labels “ethylene” and “ethanol” are expressed on this space. Labels that can be used other than the molecular weight and the boiling point include a composition formula, a rational formula, a structural formula, a type and a number of a functional group, a number of carbons, a degree of unsaturation, a concentration, solubility in water, a polarity, a melting point, a density, a molecular orbital, and the like. In addition, a mol2vec, which is a method of vectorially expressing a molecular structure, may be utilized.

(2) Space Representing a Sensory Evaluation Index

In a second example, a space representing an index obtained in sensory tests by humans is used as the label space. FIG. 4B illustrates an example in which a vector space with “unpleasant” and “vague” as axes is used as a sensory evaluation index as the label space, and labels “chocolate” and “air freshener” are expressed on this space. In fields such as flavors and foods, a large number of words are appropriately selected to express odors, and those words can be thus used as the sensory evaluation index to form the label space. Incidentally, as sensory tests, for instance, there are discrimination type tests such as a two-point discrimination method and a three-point discrimination method, a descriptive type test such as a scoring method or a QDA (Quantitative Descriptive Analysis) method, a time-dynamic method such as a temporal strength test, a TDS (Temporal Dominance of Sensations), a TCATA (Temporal Check All That Apply) or the like, a sensory evaluation method of a preference type using an ordinary panel, and the like.

(3) word2vec Space

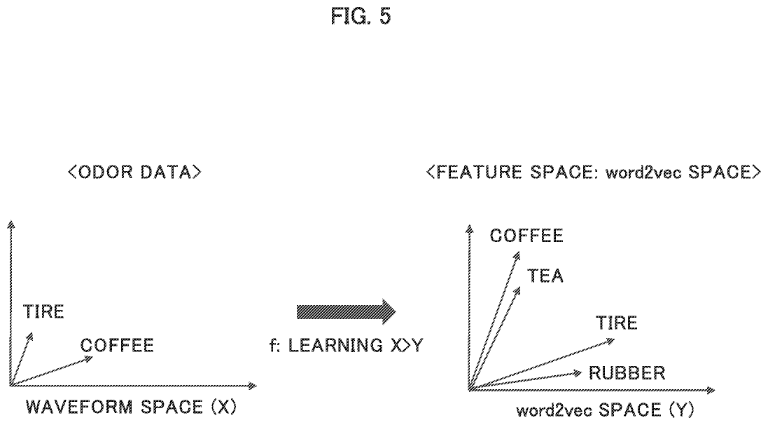

In a third example, a word2vec space is used as the label space. The “word2vec” is a method of expressing the meaning of a word with a vector (distributed representation), and in this example, the word2vec space is used as the label space. As illustrated in FIG. 5, odor data can be defined as a vector in a waveform space that defines a feature amount representing an odor waveform. The predictive model 21 transforms the odor data into a vector in the word2vec space. That is, the predictive model 21 learns a transformation from the waveform space to the word2vec space. FIG. 5 illustrates an example of specifying a “coffee,” a “tea”, a “tire”, and a “rubber”, as labels on the label space using the word2vec. As mentioned above, the word2vec space is basically a space that expresses the meanings of words; however, since it is thought that the meaning of a word and an odor we humans imagine from that word are related to some extent, a technique of expressing odor using the word2vec space is considered to be effective.

However, since the nature of the word2vec space depends on a sentence (corpus) used to learn the odor, when using the word2vec space as the label space, the word2vec needs to be learned using sentences related to the odor. Thus, the word2vec, which is learned using odor-related sentences, for instance, research documents such as papers on a sense of smell, review comments on cosmetics, review articles on food catalogues and gourmand guides, and the like, are used as the label space.

(4) Space Representing a Reaction When Smelling

As a fourth example, a label space may be formed using some biological reactions that occurs in the human body when humans smell odors. For instance, brain waves when humans smell odors, a functional magnetic resonance imaging (fMRI), a heart rate interval (RRI: RR Interval), or the like are used.

(5) Combination of First to Fourth Examples

As a fifth example, a combination of two or more of the first to fourth examples described above may be used. Specifically, first, a new label space may be created by simply combining two or more label spaces among the first to fourth examples. Alternatively, a sensory evaluation index space of the second example and a word2vec space of the third example may be used in two stages. In the sensory evaluation index, the odor is often expressed using nouns, adjectives, and onomatopes. For instance, hexane is called “odor like kerosene”, hexanal is called “odor of old rices”, and the like, and the odor is expressed by associating with an appropriate language. Accordingly, by first associating a language with an odor and then using the word2vec, which represents a distance between languages, it is possible to use the label space that is close to a sensation when humans perceive odors.

(Learning Process)

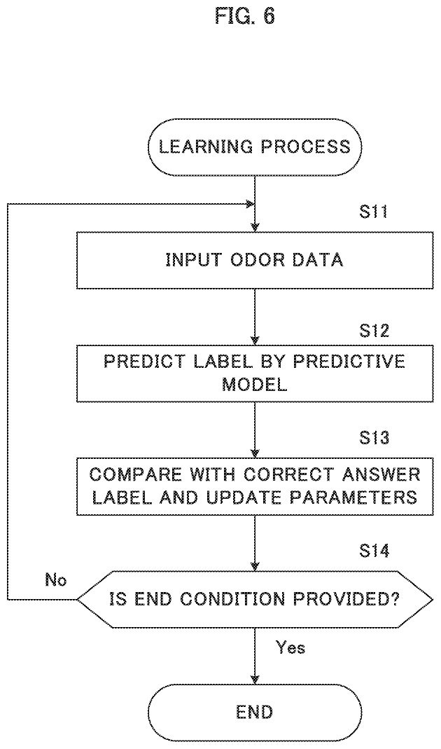

Next, a learning process performed by the prediction apparatus 10 will be described. FIG. 6 is a flowchart of the learning process. This process is performed by the processor 13, which is depicted in FIG. 2, executes a program prepared in advance, and functions as each component depicted in FIG. 3.

First, odor data are input to the prediction apparatus 10 (step S11). In this case, an output of the odor sensor 5 may be directly input to the prediction apparatus 10, or the odor data stored in the storage apparatus or the like may be input to the prediction apparatus 10. The prediction apparatus 10 predicts a label of the odor data using the predictive model 21, and outputs the predicted label (step S12). Next, the parameter update unit 22 compares the predicted label obtained from the predictive model 21 with a correct answer label of the odor data obtained from the training DB 23, and updates parameters of the predictive model based on an error (step S13).

Next, the prediction apparatus 10 determines whether or not a predetermined end condition is provided (step S14). When the end condition is not provided (step S14: No), the process returns to step S11, and steps S11 to S13 are repeated. On the other hand, when the end condition is provided (step S14: Yes), the process is terminated. Incidentally, the end condition is a predetermined condition relating to a repetition count of processes in steps S11 to S13, a degree of variation in the error between the predicted label and the correct label, or the like.

(Functional Configuration for Prediction)

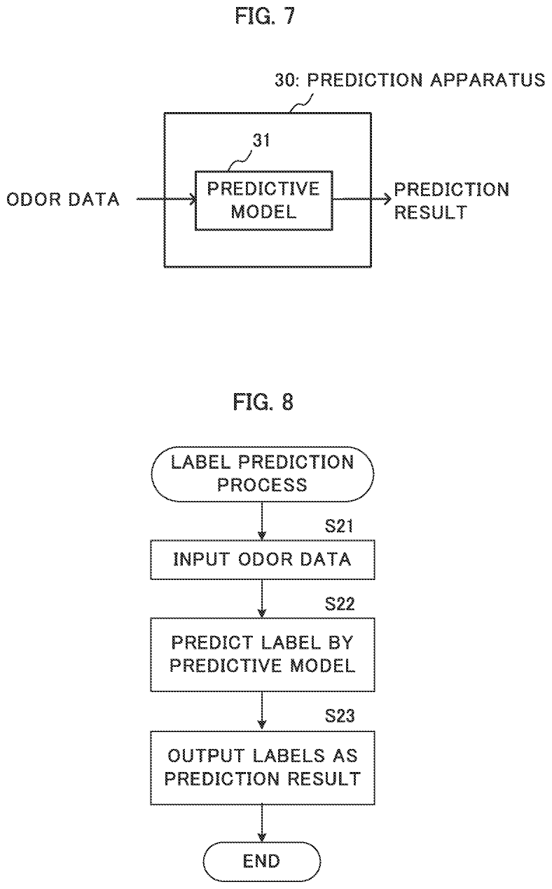

Next, a configuration for performing prediction using a predictive model trained by the above-described learning process will be described. FIG. 7 is a block diagram illustrating a functional configuration for the prediction. Incidentally, a prediction apparatus 30 includes the same hardware configuration as that of the prediction apparatus 10 depicted in FIG. 2. The prediction apparatus 30 includes a predictive model 31. The predictive model 31 is a trained model by the learning process described above, includes the same network configuration as that of the predictive model 21 used in the learning process, and includes parameters updated by the learning process. The predictive model 31 predicts and outputs a label in a predetermined label space based on the input odor data.

(Predictive Process)

Next, a prediction process by the prediction apparatus 30. FIG. 8 is a flowchart of the prediction process by the prediction apparatus 30. When odor data are input (step S21), the prediction apparatus 30 predicts a label using the predictive model 31 (step S22), and outputs the label as a prediction result (step S23). Then, the process is terminated. By this process, the prediction apparatus 30 outputs a label corresponding to the input odor data. Since this label expresses a vector quantity in a label space used in the learning process, this label quantitatively expresses the odor by a position and a direction in the label space.

### Application Example

Next, an application example of the process by the prediction apparatus 30 will be described.

(1) Distance Calculation Process

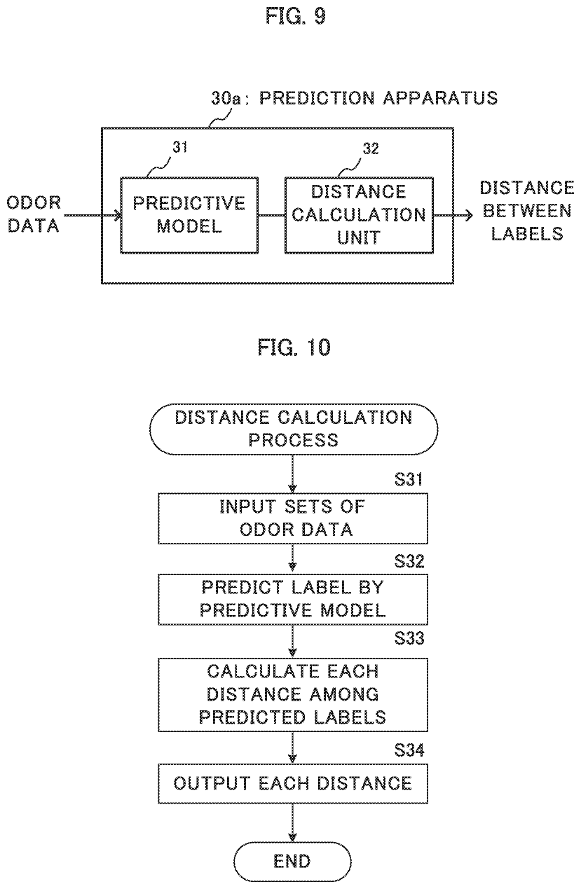

FIG. 9 illustrates a functional configuration of a prediction apparatus 30a for performing a distance calculation process. The distance calculation process is to calculate, based on a plurality of sets of input odor data, each distance among labels corresponding to the sets of input odor data. As depicted, the prediction apparatus 30a includes the predictive model 31 and a distance calculation unit 32. The predictive model 31 is the same as that of the prediction apparatus 30 illustrated in FIG. 7.

FIG. 10 is a flowchart of the distance calculation process. When a plurality of sets of odor data are input (step S31), the predictive model 31 predicts respective labels for the plurality of sets of odor data, and outputs the labels to the distance calculation unit 32 (step S32). The distance calculation unit 32 calculates each distance among a plurality of the input labels (step S33). For the distance, a Euclidean distance, Mahalanobis distance, or the like may be used. Then, the distance calculation unit 32 outputs each calculated distance among the labels (step S34). The distance calculation unit 32 may output a value of each calculated distance among the labels, or may output a level or the like which indicates each distance among the labels. The distance calculation process can determine each closeness among the plurality of sets of input odor data, and is effective for a case of quantitatively determining how close a plurality of odors are to each other.

(2) Product Proposal Process

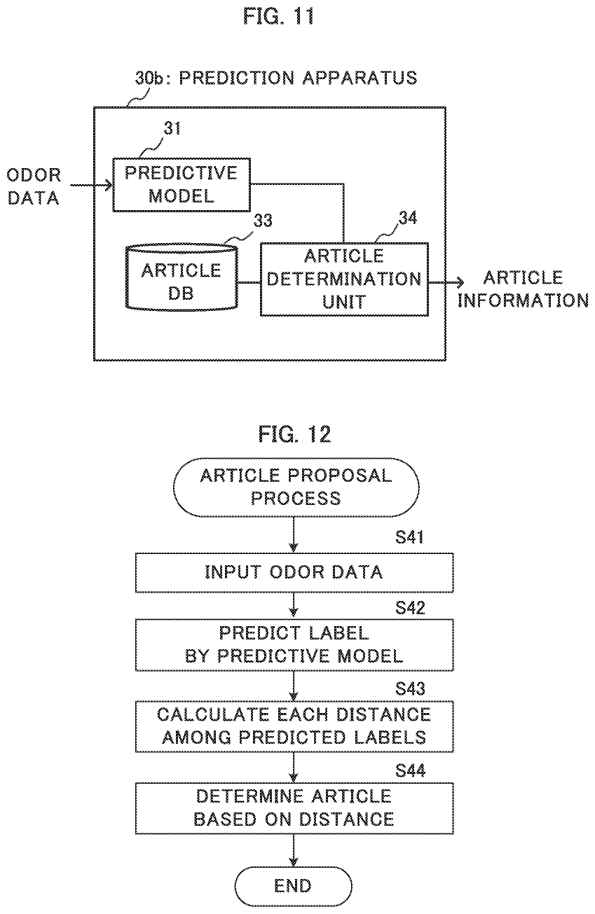

FIG. 11 illustrates a functional configuration of a prediction apparatus 30b that performs an article proposal process. The article proposal process is a process to propose an article having an odor close to the input odor data. As depicted, the prediction apparatus 30b includes the predictive model 31, an article DB 33, and an article determination unit 34. The predictive model 31 is the same as that of the prediction apparatus 30 depicted in FIG. 7. The article DB 33 stores, for each article, labels expressing an odor of that article. The article determination unit 34 calculates a distance between the label output by the predictive model 31 and a label of each article stored in the article DB 33, determines an article closer than a predetermined value, and presents information of that article. Here, articles recorded in the article DB 33 may be articles in which each odor is learned when the predictive model 31 is generated, or may be articles that have not been learned. That is, these articles only need to be labeled in the label space, and there may be no odor data. Even an article that is not used in the learning of the predictive model 31 can be proposed in a case where a label can be applied with respect to the odor of the article in the label space.

FIG. 12 is a flow chart of the article proposal process. When odor data are input (step S41), the predictive model 31 predicts a label with respect to the odor data and outputs the predicted label to the article determination unit 34 (step S42). The article determination unit 34 calculates a distance between the predicted label input from the predictive model 31 and each label of a plurality of candidate articles stored in the article DB 33 (step S43). After that, the article determination unit 34 determines one or more articles in which each distance from the predicted label is equal to or less than a predetermined value, and outputs information of one or more determined articles (step S44). According to the article proposal process, it is possible to search an article having a specific odor and a closer odor. The article proposal process can be used, for instance, to search for another perfume that is close to the perfume preferred by one customer.

(3) Odor Data Proposal Process

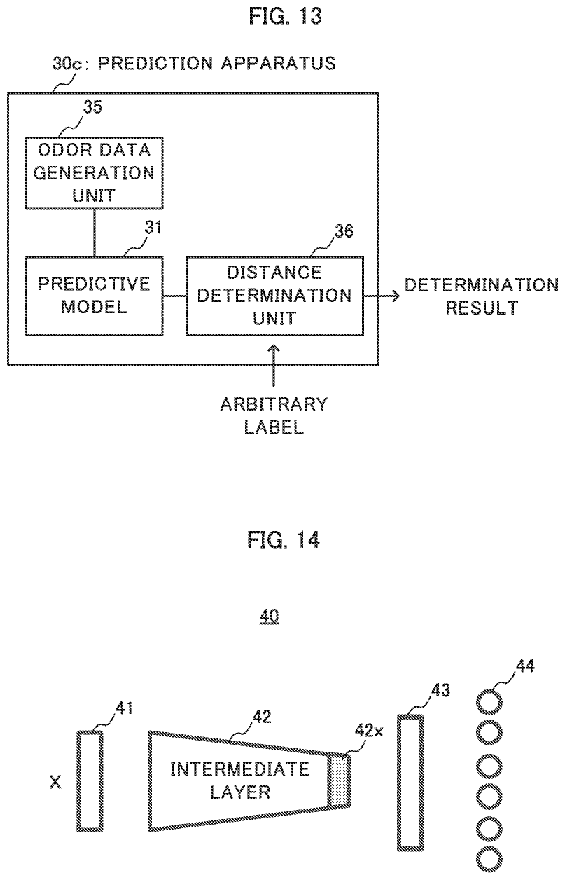

An odor data proposal process is a process to propose a form of odor data when outputting an arbitrary label. FIG. 13 illustrates a functional configuration of a prediction apparatus 30c for performing the odor data proposal process. The prediction apparatus 30c includes the predictive model 31, an odor data generation unit 35, and a distance determination unit 36. The predictive model 31 is the same as that of the prediction apparatus 30 depicted in FIG. 7. The odor data generation unit 35 systematically changes the odor data and comprehensively outputs the odor data. The predictive model 31 predicts a label for the odor data which the odor data generation unit 35 comprehensively output, and outputs to the distance determination unit 36. The distance determination unit 36 calculates a distance between the label predicted by the predictive model 31 and an arbitrary label. The distance determination unit 36 rejects when the distance is equal to or more than a constant value, adopts odor data when the distance becomes less than the constant, and outputs a determination result. The odor data proposal process can be used, for instance, in a case of searching for an odor type/combination that satisfies an arbitrary property when developing a new product.

(Modification)

In the above example, a label is represented using the label space; however, a vector representation for odor data may be generated, instead of using the label space. FIG. 14 illustrates an example for determining a label of odor data using a neural network. The neural network forming a predictive model 40 includes an input layer 41, an intermediate layer 42, and an output layer 43. The output layer 43 is formed by a softmax function or the like, and outputs a label 44 for the input odor data. As learning data, odor data and a label corresponding to the odor data are prepared, and the predictive model 40 is trained. For the label of the odor data, an odor-related label is used. Thus, once the trained predictive model 40 is obtained, a feature vector, which is obtained at a portion 42x of the intermediate layer 42 located immediately prior to the output layer 43, is used as a vector representing the input odor data. In this case, although labels used for the learning are not defined in the label space, in a state in which the predictive model 40 is trained so that a large number of labels can be correctly discriminated, it is considered that a feature vector generated by a portion 42x of the intermediate layer 42 is not explicit, however, indicates a feature of the input odor data. Accordingly, the feature vector, which is output by the portion 42x of the intermediate layer 42 with respect to the input odor data, may be used as a vector for the odor data.

### Second Example Embodiment

Next, a second example embodiment will be described.

(Data Processing Apparatus)

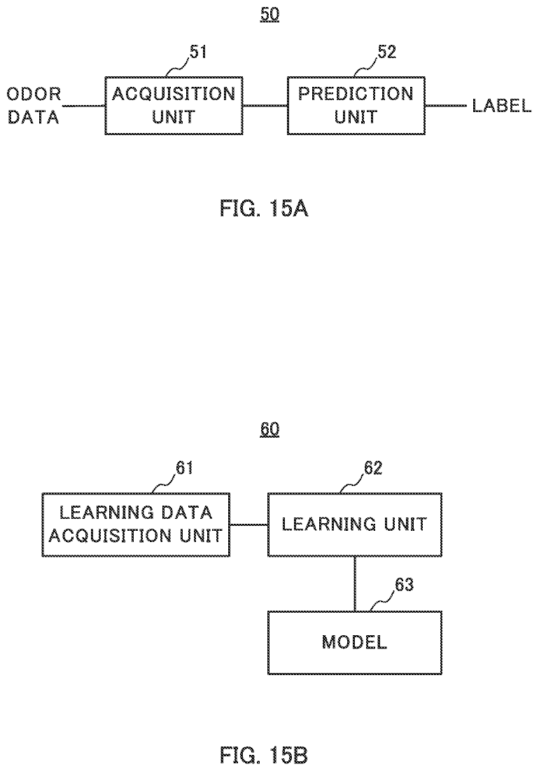

FIG. 15A is a block diagram illustrating a functional configuration of a data processing apparatus according to the second example embodiment. As depicted, the data processing apparatus 50 includes an acquisition unit 51 and a prediction unit 52. The acquisition unit 51 acquires odor data from an outside. The prediction unit 52 predicts a label in the label space of the odor data acquired by the acquisition unit 51 by using the model that has learned a relationship between the odor data and the label in the label space indicating a feature of an odor. By this process, it is possible to predict the label in the label space for the input odor data.

(Learning Apparatus)

FIG. 15B is a block diagram illustrating a functional configuration of a learning apparatus according to the second example embodiment. As illustrated, the learning apparatus 60 includes a learning data acquisition unit 61, a learning unit 62, and a model 63. The learning data acquisition unit 61 acquires learning data in which odor data of each object is associated with a label indicating the object in the label space indicating an odor feature. The learning unit 62 learns the model 63 that predicts the label in the label space of the odor data from the odor data, by using the learning data. By this configuration, it is possible to learn the model 63 that predicts the label of the odor data in the label space.

A part or all of the example embodiments described above may also be described as the following supplementary notes, but not limited thereto.

(Supplementary note 1)

A data processing apparatus comprising:

an acquisition unit configured to acquire odor data; and

a prediction unit configured to predict a label of the acquired odor data in a label space by using a model in which a relationship between sets of odor data and labels in the label space expressing features of odors is learned.

(Supplementary note 2)

The data processing apparatus according to supplementary note 1, wherein

the label space is a space expressing semantic relations of words as a distributed representation, and

the model is trained using sentences related to the odors.

(Supplementary note 3)

The data processing apparatus according to supplementary note 1, wherein

the label space is a space expressing a sensory evaluation index of the odors, and

the model is trained using sensory test results of the odors.

(Supplementary note 4)

The data processing apparatus according to supplementary note 1, wherein

the label space is a space expressing chemical properties of the odors, and

the model is trained using chemical properties of substances.

(Supplementary note 5)

The data processing apparatus according to supplementary note 1, wherein

the label space is a space expressing features of biological reactions, and

the model is trained using the features of the biological reactions when humans smell odors.

(Supplementary note 6)

The data processing apparatus according to any one of supplementary notes 1 through 5, wherein

the acquisition unit acquires two or more sets of odor data,

the prediction unit predicts labels of the two or more sets of odor data, and

the data processing apparatus further comprises a calculation unit configured to calculate each distance among the predicted labels for the two or more sets of odor data.

(Supplementary note 7)

The data processing apparatus according to any one of supplementary notes 1 through 5, further comprising:

a storage unit configured to store labels in the label space for a plurality of articles; and

an article presentation unit configured to determine an article which distance is equal to or less than a predetermined value from among distances between the label predicted by the prediction unit and respective labels of the plurality of articles stored in the storage unit.

(Supplementary note 8)

The data processing apparatus according to any one of supplementary notes 1 through 5, further comprising a distance determination unit configured to determine whether or not a distance between the label predicted by the prediction unit and an arbitrary label is equal to or less than a predetermined value, and output a determination result.

(Supplementary note 9)

The data processing apparatus according to any one of supplementary notes 1 through 8, wherein the odor data are data indicating a feature amount of an odor waveform output from an odor sensor.

(Supplementary note 10)

A learning apparatus comprising:

a learning data acquisition unit configured to acquire learning data in which odor data of each object and a label representing the object in a label space expressing features of odors are associated with each other; and

a learning unit configured to train a model for predicting a label of odor data in the label space from the odor data, by using the learning data.

(Supplementary note 11)

An information processing method, comprising:

acquiring odor data; and

predicting a label of the acquired odor data in a label space by using a model in which a relationship between sets of odor data and labels in the label space expressing features of odors is learned.

(Supplementary note 12)

A recording medium storing a program, the program causing a computer to perform a process comprising:

acquiring odor data; and

predicting a label of the acquired odor data in a label space by using a model in which a relationship between sets of odor data and labels in the label space expressing features of odors is learned.

While the invention has been described with reference to the example embodiments and examples, the invention is not limited to the above example embodiments and examples. It will be understood by those of ordinary skill in the art that various changes in form and details may be made therein without departing from the spirit and scope of the present invention as defined by the claims.

### DESCRIPTION OF SYMBOLS

5 Odor sensor
10, 30, 30a, 30b prediction apparatus
21 Predictive model
22 Parameter update unit
23 Training database
32 Distance calculation unit
33 Article database
34 Article determination unit
35 Odor data generation unit
36 Distance determination unit
50 Data processing apparatus
60 Learning apparatus

What is claimed is:

1. A data processing apparatus comprising:
a memory storing instructions; and
one or more processors configured to execute the instructions to:
acquire odor data; and
predict a label of the acquired odor data in a label space by using a model in which a relationship between sets of odor data and labels in the label space expressing features of odors is learned.

2. The data processing apparatus according to claim 1, wherein
the label space is a space expressing semantic relations of words as a distributed representation, and
the model is trained using sentences related to the odors.

3. The data processing apparatus according to claim 1, wherein
the label space is a space expressing a sensory evaluation index of the odors, and
the model is trained using sensory test results of the odors.

4. The data processing apparatus according to claim 1, wherein
the label space is a space expressing chemical properties of the odors, and
the model is trained using chemical properties of substances.

5. The data processing apparatus according to claim 1, wherein
the label space is a space expressing features of biological reactions, and
the model is trained using the features of the biological reactions when humans smell odors.

6. The data processing apparatus according to claim 1, wherein
the processor acquires two or more sets of odor data,
the processor predicts labels of the two or more sets of odor data, and
the processor calculates each distance among the predicted labels for the two or more sets of odor data.

7. The data processing apparatus according to claim 1, wherein
the memory is configured to store labels in the label space for a plurality of articles; and
the processor is configured to determine an article which distance is equal to or less than a predetermined value from among distances between the predicted label and respective labels of the plurality of articles stored in the memory.

8. The data processing apparatus according to claim 1, wherein the processor is further configured to determine whether or not a distance between the predicted label and an arbitrary label is equal to or less than a predetermined value, and output a determination result.

9. The data processing apparatus according to claim 1, wherein the odor data are data indicating a feature amount of an odor waveform output from an odor sensor.

10. A learning apparatus for use of the data processing apparatus according to claim 1, the learning apparatus comprising:
a memory storing instructions; and
one or more processors configured to execute the instructions to:
acquire learning data in which odor data of each object and a label representing the object in a label space expressing features of odors are associated with each other; and
train a model for predicting a label of odor data in the label space from the odor data, by using the learning data.

11. An information processing method, comprising:
acquiring odor data; and
predicting a label of the acquired odor data in a label space by using a model in which a relationship between sets of odor data and labels in the label space expressing features of odors is learned.

12. A non-transitory computer-readable recording medium storing a program, the program causing a computer to perform a process comprising:
acquiring odor data; and
predicting a label of the acquired odor data in a label space by using a model in which a relationship between sets of odor data and labels in the label space expressing features of odors is learned.
